(19) United States
(12) Patent Application Publication
(10) Pub. No.: US 2025/0300313 A1
(43) Pub. Date: Sep. 25, 2025

(54) ELECTRIC STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio Mori, Toyota-shi (JP); Yoshiro Kamo, Ashigarakami-gun (JP); Takahiko Nakano, Nagoya-shi (JP); Toshihiro Shimonaka, Toyota-shi (JP); Kenichi Kohashi, Sunto-gun (JP); Yuki Soda, Nagoya-shi (JP)

(73) Assignee: TOYOTA JIDOSHA KABUSHIKI KAISHA, Toyota-shi (JP)

(21) Appl. No.: 18/961,491

(22) Filed: Nov. 27, 2024

(30) Foreign Application Priority Data
Mar. 21, 2024 (JP) 2024-045049

(51) Int. Cl. H01M 50/367; H01M 50/249; H01M 50/264; H01M 50/289

(52) U.S. Cl. CPC H01M 50/367; H01M 50/249; H01M 50/264; H01M 50/289

(57) ABSTRACT

An electric storage device includes: an electric storage module that includes a plurality of electric storage cells; a case that houses the electric storage module; an adhesive layer that bonds the electric storage cells to the case; and a smoke exhaust valve provided in the case. A smoke exhaust passage extending toward the smoke exhaust valve is formed in the adhesive layer.

### CROSS-REFERENCE TO RELATED APPLICATION

This application claims priority to Japanese Patent Application No. 2024-045049 filed on Mar. 21, 2024. The disclosure of the above-identified application, including the specification, drawings, and claims, is incorporated by reference herein in its entirety.

### BACKGROUND

### 1. Technical Field

The present disclosure relates to an electric storage device.

### 2. Description of Related Art

Japanese Unexamined Patent Application Publication No. 2021-111520 (JP 2021-111520 A) discloses a battery pack including a plurality of battery cells and a battery pack case. The battery cells are bonded to the bottom surface of the battery pack case.

### SUMMARY

In the battery pack described in JP 2021-111520 A, it is considered that the discharge of smoke generated in battery cells (electric storage cells) to the outside of the case is inhibited by an adhesive material that bonds the battery cells to the battery pack case.

The present disclosure has been made to solve the above problem, and an object thereof is to provide an electric storage device that can easily discharge smoke generated in electric storage cells to the outside of a case.

An electric storage device according to one aspect of the present disclosure includes: an electric storage module that includes a plurality of electric storage cells; a case that houses the electric storage module; an adhesive member that bonds the electric storage cells to the case; and a smoke exhaust valve provided in the case. A smoke exhaust passage extending toward the smoke exhaust valve is formed in the adhesive member.

In the electric storage device according to one aspect of the present disclosure, as described above, the smoke exhaust passage extending toward the smoke exhaust valve is formed in the adhesive member. Thus, smoke generated in electric storage cells can be easily moved to the smoke exhaust valve through the smoke exhaust passage. As a result, the smoke generated in the electric storage cells can be easily discharged to the outside of the case.

The case may include: a covering portion that is provided to cover the electric storage cells from one side in a first direction and is bonded to the electric storage cells with an adhesive member; a peripheral wall portion that is provided to surround the electric storage cells when viewed from the one side, and is provided with the smoke exhaust valves; and a partition wall portion that partitions the space in the case housing the electric storage cells into a plurality of spaces when viewed from the one side. The smoke exhaust passage may extend from the partition wall portion toward the smoke exhaust valve on the peripheral wall portion when viewed from the one side. Here, smoke from electric storage cells tends to accumulate in the partition wall portion provided between the electric storage cells. Therefore, the smoke exhaust passage extending from the partition wall portion toward the smoke exhaust valve is particularly effective for discharging the smoke to the outside of the case.

Each of the electric storage cells may be formed long in a second direction when viewed from the one side. An exhaust portion may be formed at one end of each of the electric storage cells in the second direction. The electric storage cells may be arrayed in a third direction intersecting the second direction when viewed from the one side. The partition wall portion may include a first partition wall extending in the third direction. The electric storage cells may be arranged such that a plurality of the exhaust portions is arrayed along the first partition wall in the third direction. This configuration allows smoke discharged from the exhaust portions arrayed along the first partition wall to flow easily into the smoke exhaust passage extending from the first partition wall toward the smoke exhaust valve.

The peripheral wall portion may include a first side wall extending in the third direction. The smoke exhaust valve may be provided on the first side wall. The smoke exhaust passage may be formed to extend in the second direction between the first partition wall and the first side wall. This configuration allows the length of the smoke exhaust passage to be reduced compared to when the smoke exhaust passage extends to bend between the first partition wall and the first side wall. As a result, smoke can be quickly discharged through the smoke exhaust passage.

The partition wall portion may include a second partition wall extending in the second direction. An intersecting smoke exhaust passage may be formed in the adhesive member, the intersecting smoke exhaust passage extending from the second partition wall toward the peripheral wall portion and intersecting the smoke exhaust passage. This configuration allows smoke generated in the electric storage cells to be discharged to the outside of the case through the intersecting smoke exhaust passage. As a result, the smoke in the case can be more efficiently discharged to the outside of the case.

According to the present disclosure, smoke generated in the electric storage cells can be easily discharged to the outside of the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a configuration of a vehicle in which an electric storage device according to an embodiment is installed;

FIG. 2 is an exploded perspective view illustrating a configuration of the electric storage device and a vehicle frame according to the embodiment;

FIG. 3 is an exploded perspective view illustrating a detailed configuration of the electric storage device according to the embodiment;

FIG. 4 is a perspective view illustrating a configuration of an electric storage cell according to the embodiment;

FIG. 5 is a plan view illustrating the configuration of the electric storage device according to the embodiment;

FIG. 6 is a first cross-sectional view illustrating the configuration of the electric storage device according to the embodiment;

FIG. 7 is a partially enlarged plan view illustrating the configuration of the electric storage device according to the embodiment;

FIG. 8 is a second cross-sectional view illustrating the configuration of the electric storage device according to the embodiment; and

FIG. 9 is a plan view illustrating a configuration of an electric storage device according to a modification of the embodiment.

### DETAILED DESCRIPTION OF EMBODIMENTS

An embodiment and modifications according to the present disclosure will be described below with reference to the drawings. In the following description, identical parts and components are denoted by the same reference numerals. These parts and components also have the same names and functions. Therefore, a detailed description of these will not be repeated. Note that the embodiment and modifications to be described below may be selectively combined as appropriate.

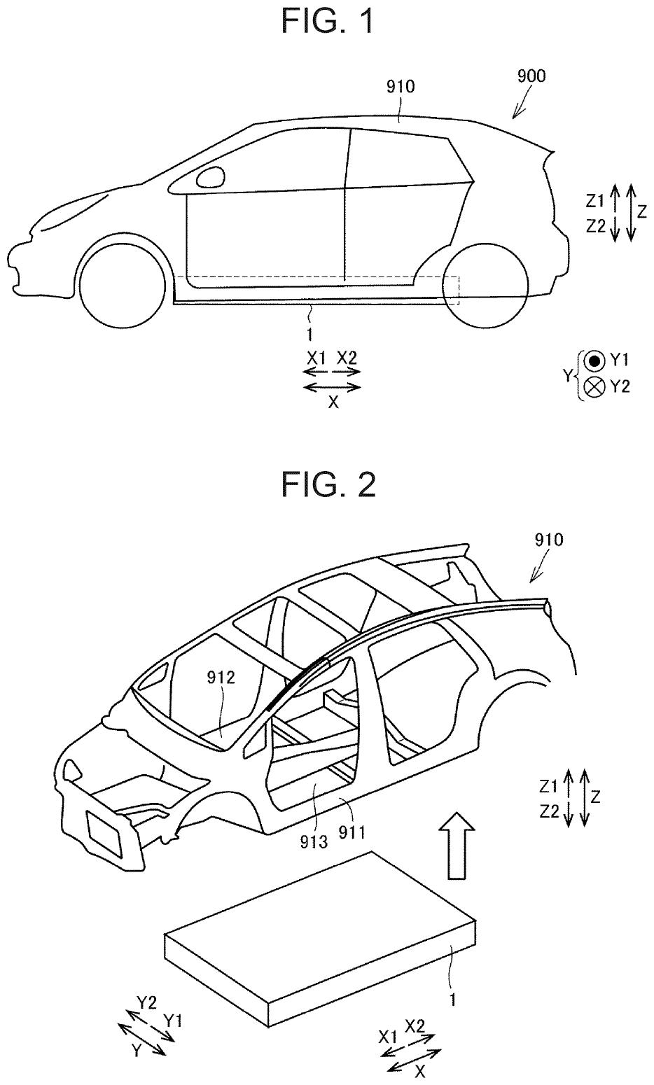

Referring to FIGS. 1 to 8, an electric storage device according to the present embodiment will be described. FIG. 1 is a side view schematically illustrating a vehicle 900 equipped with an electric storage device 1 according to the present embodiment. Note that the X direction, Y direction, and Z direction in the present specification are directions orthogonal to each other. For example, the X direction and Y direction are the front-rear direction and width direction of the vehicle 900, respectively, when the electric storage device 1 is installed in the vehicle 900. The Z direction is the height (vertical) direction. Note that the X direction and Y direction are examples of a “second direction” and “third direction” in the present disclosure, respectively. The Z direction is a “first direction” in the present disclosure. A Z1 side is an example of “one side of the first direction” in the present disclosure.

Referring to FIG. 1, the electric storage device 1 is disposed below a floor panel 913 (FIG. 2) of the vehicle 900. Examples of the vehicle 900 include a hybrid electric vehicle, a plug-in hybrid electric vehicle, a fuel cell electric vehicle, and a battery electric vehicle. The vehicle 900 includes the electric storage device 1 and a vehicle frame 910.

FIG. 2 is an exploded perspective view schematically illustrating the electric storage device 1 and the vehicle frame 910. Referring to FIG. 2, the vehicle frame 910 includes a left frame 911 and a right frame 912.

The left frame 911 and the right frame 912 are disposed at the bottom of the vehicle frame 910. The left frame 911 and the right frame 912 are spaced apart in the width direction (Y direction) of the vehicle 900. Each of the left frame 911 and the right frame 912 is disposed to extend in the front-rear direction (X direction) of the vehicle 900.

A floor panel 913 is provided between the left frame 911 and the right frame 912. The electric storage device 1 is disposed below the floor panel 913 and fixed to the left frame 911 and the right frame 912.

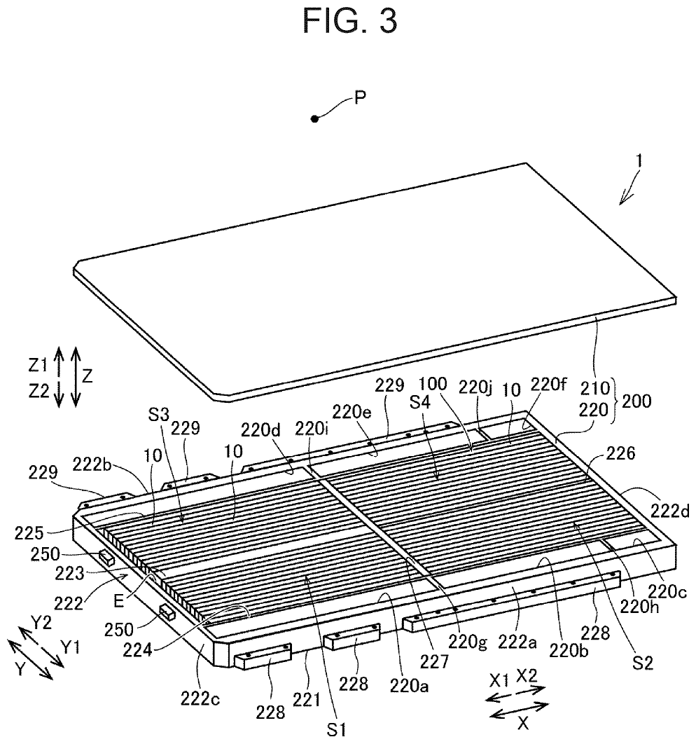

FIG. 3 is a perspective view schematically illustrating the electric storage device 1. Referring to FIG. 3, the electric storage device 1 includes an electric storage module 100 including a plurality of electric storage cells 10, a case 200 housing the electric storage module 100, an adhesive layer 300 (FIG. 5), and a smoke exhaust valve 250. In FIG. 3, the adhesive layer 300 is not illustrated for simplicity. Note that the adhesive layer 300 is an example of an “adhesive member” in the present disclosure.

The electric storage cell 10 is a secondary battery, typically a lithium-ion secondary battery. The lithium-ion secondary battery is a battery using lithium as a charge carrier, and can include all-solid-state batteries with solid electrolytes as well as a lithium-ion secondary battery with a liquid electrolyte. Note that the electric storage cell 10 is not limited to a lithium-ion secondary battery, and may be formed of a nickel-metal hydride secondary battery or another secondary battery.

Each of the electric storage cells 10 is disposed to extend in the front-rear direction (X direction) of the vehicle 900 (cf. FIG. 1). The electric storage cells 10 are arrayed in the width direction (Y direction) of the vehicle 900.

The case 200 includes an upper cover 210 and a lower case 220. FIG. 3 illustrates the electric storage device 1 with the upper cover 210 removed. Note that the upper cover 210 is an example of a “covering portion” in the present disclosure.

The upper cover 210 is provided to cover the electric storage cells 10 (electric storage modules 100) from the Z1 side.

The lower case 220 includes a bottom plate 221, a peripheral wall portion 222, and a plurality of partition walls 223, 224, 225, 226, 227. The partition walls 223, 224, 225, 226, 227 partition the space in the case 200 into a plurality of spaces. The partition walls 223, 224, 225, 226, 227 are provided on the bottom plate 221.

The bottom plate 221 is formed in a flat plate shape. The bottom plate 221 is provided to support the electric storage cells 10 (electric storage modules 100) from the Z2 side.

The peripheral wall portion 222 is formed to extend from the outer peripheral edge of the bottom plate 221 toward the top of the vehicle 900. The peripheral wall portion 222 is formed in an annular shape. The peripheral wall portion 222 is provided to surround the electric storage cells 10 (electric storage modules 100) when viewed from the Z1 side. Note that the term “viewed from the Z1 side” means “viewed from a point P separated from the electric storage module 100 and the peripheral wall portion 222 toward the Z1 side.”

The peripheral wall portion 222 includes a side wall 222a, a side wall 222b, a side wall 222c, and a side wall 222d. The side wall 222a is provided to extend in the X direction on the Y1 side of the electric storage module 100. The side wall 222b is provided to extend in the X direction on the Y2 side of the electric storage module 100. The side wall 222c is provided to extend in the Y direction on the X1 side of the electric storage module 100. The side wall 222d is provided to extend in the Y direction on the X2 side of the electric storage module 100. Note that each of the side wall 222c and side wall 222d is an example of a “first side wall” in the present disclosure.

When viewed from the Z1 side, the partition walls 223, 226, 227 partition the space in the case 200 housing the electric storage cells 10 into a plurality of spaces. In other words, when viewed from the Z1 side, the partition walls 223, 226, 227 partition the spaces (S1 to S4 described later) housing the electric storage cells 10.

The partition walls 223, 224, 225, 226 are formed to extend in the front-rear direction (X direction) of the vehicle 900. The partition wall 227 is formed to extend in the width direction (Y direction) of the vehicle 900. Note that the partition wall 227 is an example of a “first partition wall” and a “partition wall portion” in the present disclosure. The partition wall 223 and partition wall 226 are examples of a “second partition wall” and the “partition wall portion” in the present disclosure.

The partition wall 227 is disposed at the center of the lower case 220 in the X direction. Each of the partition wall 223 and partition wall 226 is disposed at the center of the lower case 220 in the Y direction. The partition wall 223 is disposed on the X1 side of the partition wall 227. The partition wall 226 is disposed on the X2 side of the partition wall 227. The partition wall 224 is disposed to extend in the X direction on the Y1 side of the electric storage cells 10. The partition wall 225 is disposed to extend in the X direction on the Y2 side of the electric storage cells 10.

A hole 220a, hole 220b, hole 220c, hole 220d, hole 220e, and hole 220f are formed in the lower case 220.

The hole 220a, hole 220b, and hole 220c are formed to extend in the X direction between the side wall 222a and the partition wall 224. The hole 220a is provided on the X1 side of the hole 220b. The hole 220c is provided on the X2 side of the hole 220b.

The hole 220d, hole 220e, and hole 220f are formed to extend in the X direction between the side wall 222b and partition wall 225. The hole 220d is provided on the X1 side of the hole 220e. The hole 220f is provided on the X2 side of the hole 220e. Note that the holes 220a to 220f may not be formed in the lower case.

The lower case 220 includes a partition wall 220g, partition wall 220h, partition wall 220i, and partition wall 220j.

The partition wall 220g extends in the Y direction between the hole 220a and hole 220b to connect the partition wall 224 to the side wall 222a. The partition wall 220h extends in the Y direction between the hole 220b and hole 220c to connect the partition wall 224 to the side wall 222a.

The partition wall 220i extends in the Y direction between the hole 220d and hole 220e to connect the partition wall 225 to the side wall 222b. The partition wall 220j extends in the Y direction between the hole 220e and hole 220f to connect the partition wall 225 to the side wall 222b.

Note that each of the partition wall 223, partition wall 224, partition wall 225, partition wall 226, partition wall 227, partition wall 220g, partition wall 220h, partition wall 220i, and partition wall 220j is not bonded to the upper cover 210. The upper cover 210 is formed to be relatively easier to deform than, for example, the lower case 220 and the like.

Thus, when the internal pressure caused by smoke increases in the vicinity of each of the partition walls, the upper cover 210 expands toward the Z1 side at that position. As a result, a gap is formed between each of the partition walls and the upper cover 210. In this instance, the smoke passes through the gap and circulates in the lower case 220.

The electric storage cells 10 are arranged in spaces S1 to S4 in the lower case 220. The space S1 is a space surrounded by the partition wall 223, partition wall 224, partition wall 227, and the side wall 222c. The space S2 is a space surrounded by the partition wall 226, partition wall 224, partition wall 227, and the side wall 222d. A region E, in which equipment or the like (not illustrated) is disposed, is provided between the side wall 222c and the electric storage module 100.

The space S3 is a space surrounded by the partition wall 225, partition wall 223, partition wall 227, and the side wall 222c. The space S4 is a space surrounded by the partition wall 225, partition wall 226, partition wall 227, and the side wall 222d.

The lower case 220 further includes a plurality of support portions 228 and a plurality of support portions 229. Each of the support portions 228 and support portions 229 is fixed to the vehicle frame 910 (FIG. 2). For example, a hole is formed in each of the support portions 228 and support portions 229 for fitting a bolt. By fitting the bolts into the holes, each of the support portions 228 is fixed to the left frame 911 (FIG. 2), and each of the support portions 229 is fixed to the right frame 912 (FIG. 2).

The smoke exhaust valve 250 is provided in the lower case 220. Specifically, the smoke exhaust valve 250 is provided on each of the side wall 222c and side wall 222d. Two smoke exhaust valves 250 are provided on each of the side wall 222c and side wall 222d. On each of the side wall 222c and side wall 222d, the smoke exhaust valves 250 are provided at a position on the Y1 side and a position on the Y2 side with respect to the partition wall 223 (partition wall 226).

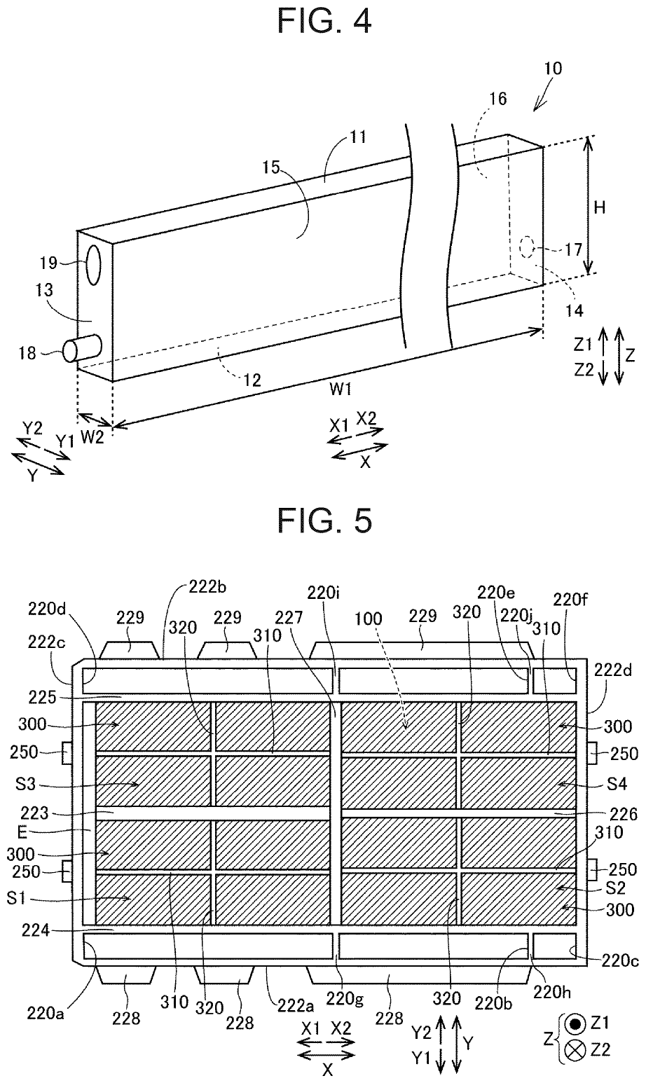

FIG. 4 illustrates an example of the electric storage cell 10. Referring to FIG. 4, the electric storage cell 10 includes an upper surface 11, a lower surface 12, a short side surface 13, a short side surface 14, a long side surface 15, and a long side surface 16. Note that the short side surface 13 is an example of “one end” in the present disclosure.

Each of the upper surface 11 and the lower surface 12 is a surface in the Z direction of the electric storage cell 10. Specifically, the upper surface 11 is the Z1-side end surface of the electric storage cell 10. The lower surface 12 is the Z2-side end surface of the electric storage cell 10 and is provided on the side opposite to the upper surface 11 in the Z direction.

Each of the short side surface 13 and short side surface 14 is a surface in the X direction of the electric storage cell 10. Specifically, the short side surface 13 and short side surface 14 are one end surface in the X direction and the other end surface in the X direction of the electric storage cell 10, respectively.

Each of the long side surface 15 and long side surface 16 is a surface in the Y direction of the electric storage cell 10. Specifically, the long side surface 15 and long side surface 16 are one end surface in the Y direction and the other end surface in the Y direction of the electric storage cell 10, respectively.

The electric storage cell 10 is formed long in the X direction. Specifically, a width W1 in the X direction of the electric storage cell 10 is larger than a width W2 in the Y direction of the electric storage cell 10. The width W1 is larger than a height H in the Z direction of the electric storage cell 10. Note that the height H is larger than the width W2.

The electric storage cell 10 further includes a positive electrode terminal 17 and a negative electrode terminal 18. The positive electrode terminal 17 is provided on the short side surface 14. The negative electrode terminal 18 is provided on the short side surface 13.

The electric storage cell 10 further includes a cell smoke exhaust valve 19 that discharges gas in the electric storage cell 10. The cell smoke exhaust valve 19 is configured to discharge gas (smoke) in the electric storage cell 10 to the outside of the electric storage cell 10 when the internal pressure of the electric storage cell 10 increases. The cell smoke exhaust valve 19 is provided on the side surface of the electric storage cell 10. In the example illustrated in FIG. 4, the cell smoke exhaust valve 19 is provided on the short side surface 13 where the negative electrode terminal 18 is provided. Note that the cell smoke exhaust valve 19 may be provided on the short side surface 14, the long side surface 15, or long side surface 16. The cell smoke exhaust valve 19 is an example of an “exhaust portion” in the present disclosure.

FIG. 5 is a plan view illustrating the electric storage device 1 with the upper cover 210 removed. The adhesive layer 300 is disposed on the electric storage module 100. Specifically, the adhesive layer 300 is disposed (applied) on the upper surface 11 of each of the electric storage cells 10. Thus, the adhesive layer 300 bonds the electric storage cells 10 to the upper cover 210.

In detail, the adhesive layer 300 is provided for each space S1 to S4. The adhesive layer 300 is disposed (laminated) on the electric storage cells 10 in each of spaces S1 to S4. Specifically, the adhesive layer 300 is formed by applying a gel-like adhesive material to the upper surfaces 11 of each of the electric storage cells 10. Note that the upper surfaces of the respective partition walls (223, 224, 225, 225, 227) are not covered with the adhesive layer 300. Therefore, the adhesive layers 300 in spaces S1 to S4 are separated from each other. Note that the adhesive layer 300 is formed, for example, of a resin adhesive material.

Here, in conventional electric storage devices, it is considered that the discharge of smoke generated in the electric storage cells to the outside of the case is inhibited by the adhesive material that bonds the electric storage cell to the case.

Therefore, in the present embodiment, a smoke exhaust passage 310 extending toward the smoke exhaust valve 250 is formed in the adhesive layer 300. The smoke exhaust passage 310 is formed by providing a cavity (a space not filled with the adhesive material) below the upper cover 210.

The smoke exhaust passage 310 is provided in each of spaces S1 to S4. In each of spaces S1 to S4, the smoke exhaust passage 310 is formed to extend in the Y direction. Each of the smoke exhaust passages 310 is formed in a straight line. Specifically, each of the smoke exhaust passages 310 extends in a straight line in the X direction without bending.

The smoke exhaust passage 310 in space S1 extends from the partition wall 227 toward the Y1-side smoke exhaust valve 250 on the side wall 222c. The smoke exhaust passage 310 in space S2 extends from the partition wall 227 toward the Y1-side smoke exhaust valve 250 on the side wall 222d.

The smoke exhaust passage 310 in space S3 extends from the partition wall 227 toward the Y2-side smoke exhaust valve 250 on the side wall 222c. The smoke exhaust passage 310 in space S4 extends from the partition wall 227 toward the Y2-side smoke exhaust valve 250 on the side wall 222d.

Each smoke exhaust passage 310 is disposed at a position overlapping a position (range) in the Y direction where the smoke exhaust valve 250 is provided. The smoke exhaust passage 310 is disposed at the center of each of spaces S1 to S4 in the Y direction.

Note that the term “the smoke exhaust passage 310 extends from the partition wall 227” also includes an instance where the smoke exhaust passage 310 extends from the vicinity of the partition wall 227 and a slight gap is formed between the smoke exhaust passage 310 and the partition wall 227. A similar definition applies when similar expressions appear below.

In each of spaces S1 to S4, the smoke exhaust passage 310 extends from the X1-side end to the X2-side end of the adhesive layer 300.

A smoke exhaust passage 320 intersecting the smoke exhaust passage 310 is formed in the adhesive layer 300 in each of spaces S1 to S4. The smoke exhaust passage 320 is formed by providing a cavity (a space not filled with an adhesive material) below the upper cover 210. Each of the smoke exhaust passages 320 is formed to extend in the Y direction. In each of spaces S1 to S4, the smoke exhaust passage 310 and smoke exhaust passage 320 are orthogonal. Note that the smoke exhaust passage 320 is an example of an “intersecting smoke exhaust passage” in the present disclosure.

The smoke exhaust passage 310 and smoke exhaust passage 320 are connected at the intersection of the smoke exhaust passage 310 and smoke exhaust passage 320. That is, smoke may move between the smoke exhaust passage 310 and smoke exhaust passage 320.

The smoke exhaust passage 320 in space S1 extends from the partition wall 223 toward the side wall 222a. Specifically, the smoke exhaust passage 320 in space S1 extends from the partition wall 223 to the partition wall 224. The smoke exhaust passage 320 in space S2 extends from the partition wall 226 toward the side wall 222a. Specifically, the smoke exhaust passage 320 in space S2 extends from the partition wall 226 to the partition wall 224.

The smoke exhaust passage 320 in space S3 extends from the partition wall 223 toward the side wall 222b. Specifically, the smoke exhaust passage 320 in space S3 extends from the partition wall 223 to the partition wall 225. The smoke exhaust passage 320 in space S4 extends from the partition wall 226 toward the side wall 222b. Specifically, the smoke exhaust passage 320 in space S4 extends from the partition wall 226 to the partition wall 225.

Thus, the smoke accumulated in the vicinity of each of the partition wall 223 and partition wall 226 can be moved to the side wall 222a or side wall 222b side through the smoke exhaust passage 320. The smoke that has moved from the smoke exhaust passage 320 to the smoke exhaust passage 310 can be discharged from the smoke exhaust valve 250 to the outside of the case 200.

The smoke exhaust passage 320 is provided at the center of each of spaces S1 to S4 in the X direction. In each of spaces S1 to S4, the smoke exhaust passage 320 extends from the Y1-side end to the Y2-side end of the adhesive layer 300. Therefore, in each of spaces S1 to S4, the adhesive layer 300 is divided into four portions by the smoke exhaust passage 310 and smoke exhaust passage 320.

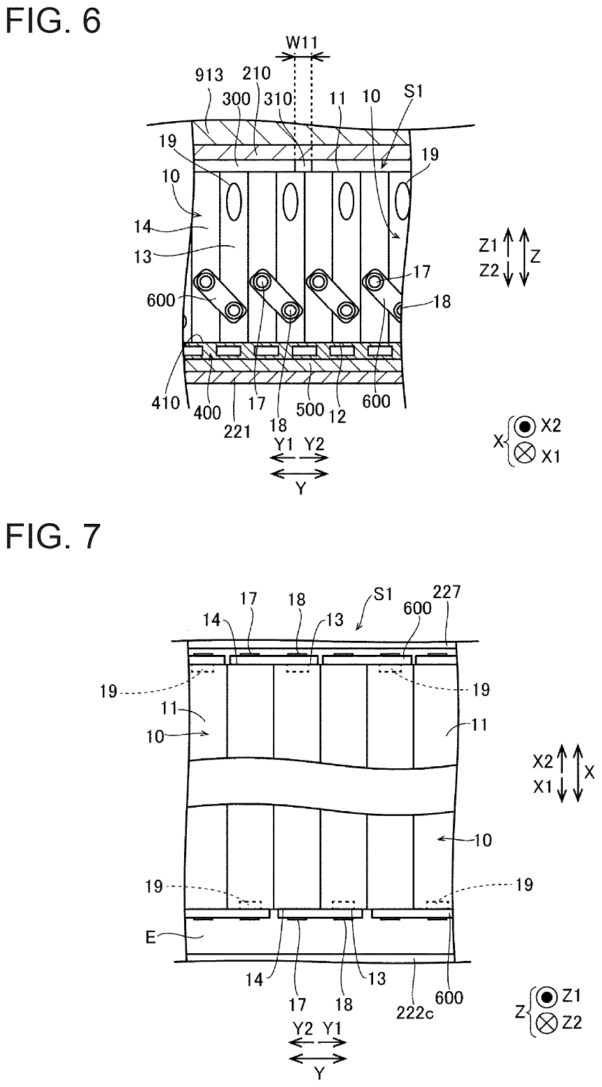

FIG. 6 is a cross-sectional view schematically illustrating the floor panel 913 and the electric storage device 1. FIG. 6 illustrates the adhesive layer 300 and the electric storage cells 10 in space S1 viewed from the X2 side. Although FIG. 6 illustrates the configuration corresponding to space S1 as a representative example, the configurations corresponding to spaces S2 to S4 are also similar.

Referring to FIG. 6, in the electric storage device 1, the electric storage cells 10 arranged such that the short side surfaces 13 face the X2 side and the electric storage cells 10 arranged such that the short side surfaces 14 face the X2 side are alternately arrayed along the Y direction.

Thus, the cell smoke exhaust valves 19 formed on the short side surfaces 13 are arrayed in the Y direction. Further, the positive electrode terminals 17 and the negative electrode terminals 18 of the electric storage cells 10 adjacent to each other in the Y direction are arranged adjacent to each other.

As illustrated in FIG. 6, the upper surface 11 of the electric storage cell 10 is exposed at a position corresponding to the smoke exhaust passage 310. In other words, no adhesive layer is provided on the Z2 side of the smoke exhaust passage 310. Note that an adhesive layer with a relatively small thickness (thickness in the Z direction) may be provided on the Z2 side of the smoke exhaust passage 310.

The smoke exhaust passage 310 has a width W11 in the Y direction. The width W11 is smaller than, for example, the width W2 (FIG. 4) in the Y direction of the electric storage cell 10. The smoke exhaust passage 310 is formed such that the width W11 at each position in the X direction is constant. Note that the width W11 may be equal to or larger than the width W2.

The smoke exhaust passage 310 has a rectangular shape when viewed along the X direction. Note that the shape of the smoke exhaust passage 310 viewed along the X direction is not limited to the above example. “Viewing the smoke exhaust passage 310 along the X direction” means viewing the smoke exhaust passage 310 from a position facing the smoke exhaust passage 310 in the X direction.

The electric storage device 1 further includes a cooler 400 that cools the electric storage cell 10. The cooler 400 includes a cooling surface 410 on which the electric storage cells 10 are arranged. The cooling surface 410 is the Z1-side end surface of the cooler 400. The cooler 400 (cooling surface 410) is provided along the lower surface 12 of the electric storage cell 10. Although FIG. 6 illustrates an example where no adhesive material (adhesive layer) is provided between the cooling surface 410 and the lower surface 12 of the electric storage cell 10, an adhesive material (adhesive layer) may be provided at this position.

The electric storage device 1 further includes an insulating plate 500. The insulating plate 500 is provided along the bottom plate 221 between the cooler 400 and the bottom plate 221.

The electric storage device 1 includes a plurality of inter-cell bus bars 600. The inter-cell bus bar 600 connects the positive electrode terminal 17 provided in one of two adjacent electric storage cells 10 in the Y direction to the negative electrode terminal 18 provided in the other of the two electric storage cells 10.

FIG. 7 is a plan view of the electric storage cells 10 in space S1, viewed from the Z1 side. In FIG. 7, the adhesive layer 300 is not illustrated for simplicity. Although FIG. 7 illustrates the configuration corresponding to space S1 as a representative example, the configurations corresponding to spaces S2 to S4 are also similar.

As illustrated in FIG. 7, the electric storage cells 10 are arranged such that a plurality of cell smoke exhaust valves 19 are arrayed in the Y direction along the partition wall 227. Specifically, the cell smoke exhaust valves 19 of the electric storage cells 10 with the short side surfaces 13 facing the partition wall 227 are arrayed in the Y direction. Thus, smoke is discharged toward the partition wall 227 from the cell smoke exhaust valves 19 arrayed along the partition wall 227. At least a part of the smoke discharged toward the partition wall 227 is discharged from the smoke exhaust valve 250 (FIG. 5) through the smoke exhaust passage 310.

The cell smoke exhaust valves 19 are arrayed in the Y direction along the side wall 222c opposite to the partition wall 227. Specifically, the cell smoke exhaust valves 19 of the electric storage cells 10 with the short side surfaces 13 facing the side wall 222c are arrayed in the Y direction. Thus, smoke is discharged toward the side wall 222c from the cell smoke exhaust valves 19 arrayed along the side wall 222c. At least a part of the smoke discharged toward the side wall 222c is discharged from the smoke exhaust valves 250 (FIG. 5) provided on the side wall 222c.

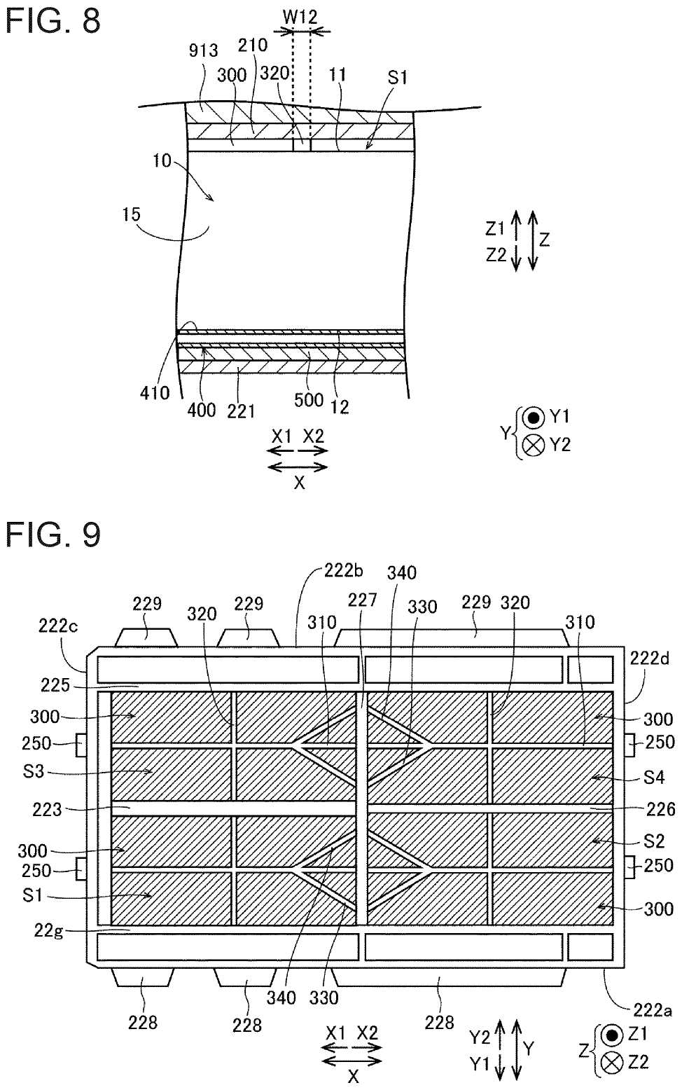

FIG. 8 is a cross-sectional view schematically illustrating the floor panel 913 and the electric storage device 1. FIG. 8 illustrates the adhesive layer 300 and the electric storage cell 10 in space S1 viewed from the Y1 side. Although FIG. 8 illustrates the configuration corresponding to space S1 as a representative example, the configurations corresponding to spaces S2 to S4 are also similar.

As illustrated in FIG. 8, the upper surface 11 of the electric storage cell 10 is exposed at a position corresponding to the smoke exhaust passage 320. In other words, no adhesive layer is provided on the Z2 side of the smoke exhaust passage 320. Note that an adhesive layer with a relatively small thickness (thickness in the Z direction) may be provided on the Z2 side of the smoke exhaust passage 320.

The smoke exhaust passage 320 has a width W12 in the Y direction. The smoke exhaust passage 320 is formed such that the width W12 at each position in the Y direction is constant. Note that the width W12 may be equal to the width W11 of the smoke exhaust passage 310, for example (FIG. 6).

The smoke exhaust passage 320 has a rectangular shape when viewed along the Y direction. Note that the shape of the smoke exhaust passage 310 viewed along the Y direction is not limited to the above example. “Viewing the smoke exhaust passage 320 along the Y direction” means viewing the smoke exhaust passage 320 from a position facing the smoke exhaust passage 320 in the Y direction.

As described above, in the above embodiment, the smoke exhaust passage 310 extending toward the smoke exhaust valve 250 is formed in the adhesive layer 300. Thus, smoke generated from the electric storage cells 10 can be moved to the smoke exhaust valve 250 through the smoke exhaust passage 310. As a result, the circulation of smoke in the case 200 can be prevented from being inhibited by the adhesive layer 300. This enables easy discharge of the smoke in the case 200.

The above embodiment has shown an example where the smoke exhaust passage 310 and smoke exhaust passage 320 are formed in the adhesive layer 300, but the present disclosure is not limited thereto. A smoke exhaust passage other than the smoke exhaust passage 310 and smoke exhaust passage 320 may be formed in the adhesive layer 300.

For example, in the example illustrated in FIG. 9, in addition to the smoke exhaust passage 310 and smoke exhaust passage 320, the smoke exhaust passage 330 and smoke exhaust passage 340 are formed in the adhesive layer 300. The smoke exhaust passage 330 and smoke exhaust passage 340 are provided in each of spaces S1 to S4. The smoke exhaust passage 330 is provided on the Y1 side of the smoke exhaust passage 310. The smoke exhaust passage 340 is provided on the Y2 side of the smoke exhaust passage 310.

Each of the smoke exhaust passage 330 and smoke exhaust passage 340 extends from the partition wall 227 to the smoke exhaust passage 310. Each of the smoke exhaust passage 330 and smoke exhaust passage 340 intersects (is connected to) the smoke exhaust passage 310. The intersection between the smoke exhaust passage 310 and each of the smoke exhaust passage 330 and smoke exhaust passage 340 is located closer to the partition wall 227 than the smoke exhaust passage 320.

The embodiment has shown an example where the smoke exhaust passage 310 and smoke exhaust passage 320 are formed in the adhesive layer 300, but the present disclosure is not limited thereto. The smoke exhaust passage 320 may not be formed in the adhesive layer 300, and only the smoke exhaust passage 310 may be formed.

The above embodiment has shown an example where the smoke exhaust passage 310 extends from the partition wall 227 toward the smoke exhaust valve 250, but the present disclosure is not limited thereto. The smoke exhaust passage may extend toward the smoke exhaust valve 250 from a position different from the partition wall 227 (e.g., partition walls 224, 225, etc.). The smoke exhaust passage 310 may not extend to the end of the adhesive layer 300 on the partition wall 227 side. The smoke exhaust passage 310 may not extend to the end of the adhesive layer 300 on the smoke exhaust valve 250 side.

The above embodiment has shown an example where the smoke exhaust valve 250 is provided on each of the side wall 222c and side wall 222d of the lower case 220, but the present disclosure is not limited thereto. The smoke exhaust valve 250 may be provided on each of the side walls 222a and 222b of the lower case 220.

The above embodiment has shown an example where the smoke exhaust passage 310 extends in the X direction, but the present disclosure is not limited thereto. The smoke exhaust passage 310 may extend toward the smoke exhaust valve 250 in a direction intersecting the X direction and Y direction when viewed from the Z1 side. Note that the smoke exhaust passage 320 may also extend in a direction intersecting the X direction and Y direction when viewed from the Z1 side.

The above embodiment has shown an example where one smoke exhaust passage 310 and one smoke exhaust passage 320 are provided in each space S1 to S4, but the present disclosure is not limited thereto. At least one of a plurality of smoke exhaust passages 310 or a plurality of smoke exhaust passages 320 may be provided in each space S1 to S4.

The above embodiment has shown an example where the positive electrode terminal 17 and the negative electrode terminal 18 are provided on different surfaces, but the present disclosure is not limited thereto. The positive electrode terminal 17 and the negative electrode terminal 18 may be provided on the same surface (short side surface 13 or short side surface 14).

The above embodiment has shown an example where the cooler 400 is provided below the electric storage cell 10, but the present disclosure is not limited thereto. The cooler may be provided above the electric storage cell. In this instance, the adhesive material having a smoke exhaust passage formed thereon may bond the lower surface 12 of the electric storage cell 10 to the lower case 220.

The above embodiment has shown an example where the electric storage cells 10 are arrayed in the Y direction orthogonal to (intersecting) the Z direction (height direction), but the present disclosure is not limited thereto. For example, the electric storage cells 10 may be arrayed (stacked) in the Z direction.

The above embodiment has shown an example where the spaces (S1 to S4) in which the electric storage cells 10 are arranged are partitioned from each other, but the present disclosure is not limited thereto. For example, the space in which the electric storage cells 10 are arranged may not be partitioned. That is, only one space in which the electric storage cells 10 are arranged may be formed.

The above embodiment has shown an example where the electric storage device 1 is installed in the vehicle 900, but the present disclosure is not limited thereto. The electric storage device 1 may be installed in electrical equipment other than the vehicle (e.g., a stationary electric storage device).

The above embodiment has shown an example where the adhesive layer 300 is formed by applying a gel-like adhesive material to the electric storage cells 10, but the present disclosure is not limited thereto. For example, the adhesive layer may be formed by disposing a sheet-like adhesive member to straddle the upper surfaces 11 of the electric storage cells 10.

The above embodiment has shown an example where the smoke exhaust passage 310 is formed such that the width W11 at each position in the X direction is constant, but the present disclosure is not limited thereto. For example, the width W11 of the smoke exhaust passage 310 in the Y direction may gradually decrease from the partition wall 227 toward the smoke exhaust valve 250. Similarly, the width W12 of the smoke exhaust passage 320 in the X direction may gradually decrease from the partition wall 223 (226) toward the peripheral wall portion 222 (222a, 222b).

The above embodiment has shown an example where the smoke exhaust passage 310 and smoke exhaust passage 320 intersect (the smoke exhaust passages are connected to each other), but the present disclosure is not limited thereto. For example, the two smoke exhaust passages may not be connected to each other due to the difference in position in the Z direction between the smoke exhaust passage extending in the X direction and the smoke exhaust passage extending in the Y direction.

The embodiments disclosed here should be considered in all respects illustrative and not restrictive. The scope of the present disclosure is indicated by the claims, not by the above description, and is intended to include all changes within the meaning and scope of the claims and their equivalents.

What is claimed is:

1. An electric storage device comprising:
an electric storage module that includes a plurality of electric storage cells;
a case that houses the electric storage module;
an adhesive member that bonds the electric storage cells to the case; and
a smoke exhaust valve provided in the case, wherein a smoke exhaust passage extending toward the smoke exhaust valve is formed in the adhesive member.

2. The electric storage device according to claim 1, wherein:
the case includes
a covering portion that is provided to cover the electric storage cells from one side in a first direction and is bonded to the electric storage cells with the adhesive member,
a peripheral wall portion that is provided to surround the electric storage cells when viewed from the one side, and is provided with the smoke exhaust valve, and
a partition wall portion that partitions a space in the case housing the electric storage cells into a plurality of spaces when viewed from the one side; and
the smoke exhaust passage extends from the partition wall portion toward the smoke exhaust valve on the peripheral wall portion when viewed from the one side.

3. The electric storage device according to claim 2, wherein:
each of the electric storage cells is formed long in a second direction when viewed from the one side;
an exhaust portion is formed at one end of each of the electric storage cells in the second direction;
the electric storage cells are arrayed in a third direction intersecting the second direction when viewed from the one side;
the partition wall portion includes a first partition wall extending in the third direction; and
the electric storage cells are arranged such that a plurality of the exhaust portions is arrayed along the first partition wall in the third direction.

4. The electric storage device according to claim 3, wherein:
the peripheral wall portion includes a first side wall extending in the third direction;
the smoke exhaust valve is provided on the first side wall; and
the smoke exhaust passage is formed to extend in the second direction between the first partition wall and the first side wall.

5. The electric storage device according to claim 3, wherein:
the partition wall portion includes a second partition wall extending in the second direction; and
an intersecting smoke exhaust passage is formed in the adhesive member, the intersecting smoke exhaust passage extending from the second partition wall toward the peripheral wall portion and intersecting the smoke exhaust passage.
